(19) United States
(12) Patent Application Publication
(10) Pub. No.: US 2015/0364066 A1
(43) Pub. Date: Dec. 17, 2015

(54) BACK-LIT PRINTED PANEL

(71) Applicant: SUNPARTNER TECHNOLOGIES, Aix-en-Provence (FR)

(72) Inventors: Eddy DJAFER, Lyon (FR); Pierre Henry BASSOULS, Lantignie (FR)

(73) Assignee: SUNPARTNER TECHNOLOGIES, Aix En Provence. OT (FR)

(21) Appl. No.: 14/764,248

(22) PCT Filed: Jan. 27, 2014
(86) PCT No.: PCT/FR2014/050152

§ 371 Date: Jul. 29, 2015

(30) Foreign Application Priority Data
Jan. 31, 2013 (FR) 1350822

(51) Int. Cl. G09F 13/16; F21S 9/03; G09F 13/04

(52) U.S. Cl. CPC G09F 13/16; G09F 13/04; F21S 9/037; F21Y 2101/02

(57) ABSTRACT

A printed panel for displaying an image includes at least one printed image formed by a plurality of opaque parallel strips that are evenly spaced from one other and separated by transparent strips; an optical system formed by the juxtaposition of two flat lenses, the flat lenses of the optical system being arranged in parallel to the plurality of opaque and transparent strips of the printed image; and at least one photovoltaic panel having a surface for collecting sunlight that is arranged opposite a rear surface of the optical system.

### TECHNICAL FIELD

The invention relates to the field of display of an image possibly in particular conveying a promotional message or more generally information. Such a printed panel thus allows a message to be displayed and may be used in various types of applications such as for example billboards, pieces of urban furniture, store signs or even road signs.

The invention more particularly relates to a printed panel in which the image is formed by a plurality of opaque bands that are spaced apart from each other and separated by transparent bands. An optical system then makes it possible to create the illusion that the opaque bands are contiguous and form a continuous image.

Such an arrangement then makes it possible for solar radiation to pass through the transparent bands of the image and reach a photovoltaic panel located on a back side of the image.

### PRIOR ART

Generally, such printed panels have been described in document FR 2 896 596, in which an image is printed on a transparent film. Such an image is made up of a plurality of opaque rectilinear bands and transparent rectilinear bands.

Such printed panels thus allow an image to be seen on the surface of solar panels and therefore the solar panels, which are often unattractive, to be intelligently masked. The image thus added however only partially obstructs direct solar rays, thereby allowing them to function with a minimum loss of insulation. Such a printed panel also makes it possible to facilitate the esthetic integration of solar panels, especially into billboards or signs.

However, such a type of printed panel only allows the message to be displayed during periods of the day when solar radiation is present and reflected by the opaque bands of the image.

Such a type of printed panel is therefore useless during the night since it cannot both collect luminous solar radiation and backlight the image.

Thus, the aim of the invention is to allow the message formed by the image to be seen between daylight periods without however degrading the transmission of light during daylight periods.

### SUMMARY OF THE INVENTION

The invention therefore relates to a printed panel allowing an image to be displayed, comprising:
at least one printed image formed by a plurality of parallel opaque bands regularly spaced from each other and separated by transparent bands;
an optical system formed by a juxtaposition of rectilinear lenses, the rectilinear lenses of the optical system being arranged parallel to the plurality of opaque and transparent bands of the printed image; and
at least one photovoltaic panel, the side of the photovoltaic panel which is intended to collect sunlight being arranged facing a back side of said optical system;
   said printed panel being characterized in that it comprises at least one backlighting device arranged facing the back side of the optical system, the backlighting device being able to backlight the printed image, allowing the printed image to be seen in the absence of sunlight, and being able to allow, at least temporarily, at least some of the sunlight passing through the transparent bands of the printed image to be transmitted, this sunlight being collected by the photovoltaic panel.

In other words, the printed panel allows an image to be backlit during periods when there is no or little solar radiation, i.e. during the night. The backlighting device however allows light to be transmitted to the photovoltaic panel during daylight periods.

Moreover, a white background may be added as the last or first of the printed layers used to form the opaque bands of the printed image. Such a white background is thus oriented so as to face the photovoltaic panel and allows sunlight to be reflected in the direction of the photovoltaic panel. The white background layer also allows the contrast between the colors forming the printed image to be increased.

According to a first embodiment, the printed image may be added to a film interposed between the back side of the optical system and the side intended to collect sunlight of the photovoltaic panel.

In this case, the image is printed on an independent medium that is then inserted between the optical system and the photovoltaic panel. Such an embodiment may thus be advantageous in that it allows the printed image of the panel to be changed inexpensively.

According to a second embodiment, the printed image may be printed on the front side of the optical system.

Thus, the image is printed directly on the optical system and it is possible to change the printed image by simply replacing the optical system forming an external face of the printed panel.

According to a third embodiment, the printed image may be printed on the back side of the optical system.

Just as before, the image is therefore printed directly on the optical system and it is possible to change the printed image by simply replacing the optical system forming an external face of the printed panel.

Moreover, such a backlighting device may be formed in various ways and especially comprise point or area light sources.

Thus, according to a first variant of the invention, the backlighting device may comprise a plurality of point sources.

Such point sources may especially take the form of light-emitting diodes (LEDs) distributed and arranged in various ways.

In this case, the point sources may be regularly distributed in a plane parallel to that in which the optical system is located while being orientated so as to directly illuminate the back side of the optical system.

In other words, the point sources are arranged facing the back side of the optical system and allow the latter to be illuminated directly. The point sources are then regularly spaced from each other so as to guarantee the uniformity of the illumination.

According to a first embodiment, the point sources may be arranged on a carrier inserted between the photovoltaic panel and the optical system.

Such a carrier may especially take the form of a film or a transparent sheet. The point sources may then be securely fastened to the carrier by adhesive bonding, soldering or clip fastening so as to immobilize them relative to each other.

According to a second embodiment, the point sources may be arranged on the photovoltaic panel on the side intended to collect sunlight.

Thus, no carrier of point sources is inserted between the optical system and the photovoltaic panel. The point sources are advantageously positioned level with inactive zones of the photovoltaic panel and therefore do not generate transmission losses with respect to the light energy collected by the cells of the photovoltaic panel.

According to one particular embodiment, the backlighting device may comprise a transparent sheet, the point sources being arranged on the periphery of the transparent sheet and being oriented so as to illuminate the edge face of the transparent sheet.

In other words, in this case the point sources are not arranged directly facing the back side of the optical system. They are positioned on the periphery of a transparent sheet possessing substantially the same dimensions as the optical system. Such point sources illuminate the edge face of the transparent sheet and thus perpendicularly relative to the plane in which the optical system is located.

In this case, the transparent sheet may comprise a plurality of grooves intended to reflect the light in the direction of the back side of the optical system.

In other words, the light rays produced by the point sources are reflected and deviated by the grooves produced in the transparent sheet. Such grooves may be produced in various ways and especially by processes for etching or mechanical machining of one side of the transparent sheet.

Advantageously, the plurality of grooves may form a network of parallel lines, the spacing between two consecutive lines varying as a function of the distance separating the lines and a parallel edge face of the sheet.

In this way, a uniform illumination may be obtained over the entire area of the backlighting device.

In practice, the transparent sheet may transmit at least 95% of the incident sunlight in the direction of the photovoltaic panel.

Thus, the presence of the grooves in the transparent sheet only partially limits the transmission of the sunlight. Such an arrangement is therefore a good compromise as regards, on the one hand, obtaining optimal backlighting of the printed image and, on the other hand, allowing optimal collection of the solar light energy by the photovoltaic panel.

According to a second variant of the invention, the backlighting device may be formed by a completely illuminating area inserted between the photovoltaic panel and the optical system.

In this case, the backlighting device may especially be formed by a film using an organic LED

(OLED) technology. Such a backlighting device is particularly advantageous because it may present no obstacle to the incident sunlight. It thus allows transmission losses with respect to the sunlight collected by the photovoltaic panel to be optimally limited.

Advantageously, the printed panel may comprise a means for storing the electrical power generated by the photovoltaic panel, the storing means having a planar geometry and extending facing a back side of the photovoltaic panel.

In other words, such a printed panel may allow electrical power to be generated and stored. It may thus be electrically autonomous and not need to be connected electrically to the mains. Specifically, such a type of printed panel may be particularly advantageous for certain isolated locations that are located far from any power line.

### BRIEF DESCRIPTION OF THE FIGURES

How the invention is meant to be implemented and the advantages that result therefrom will become more clearly apparent from the following description of an embodiment thereof, given by way of nonlimiting example and with reference to the figures, in which:

FIG. 1 is an exploded perspective view showing the various constituent elements of a printed panel according to the invention.

FIG. 2 is an exploded perspective view of a first variant of a backlighting device allowing such a printed panel to be backlit.

FIG. 3 is a front view of a second variant of a backlighting device.

FIG. 4a is an exploded perspective view of a third variant of a backlighting device.

FIG. 4b is a cross-sectional view of the third variant of a backlighting device.

FIG. 4a is an exploded perspective view of a third variant of a backlighting device. FIG. 5 is an exploded perspective view of a fourth variant of a backlighting device.

FIGS. 6 and 7 are cross-sectional side views showing two variants of printed panels in which the printed image is printed directly on an optical system.

### DETAILED DESCRIPTION OF THE INVENTION

As mentioned above, the invention relates to a printed panel allowing an image to be displayed.

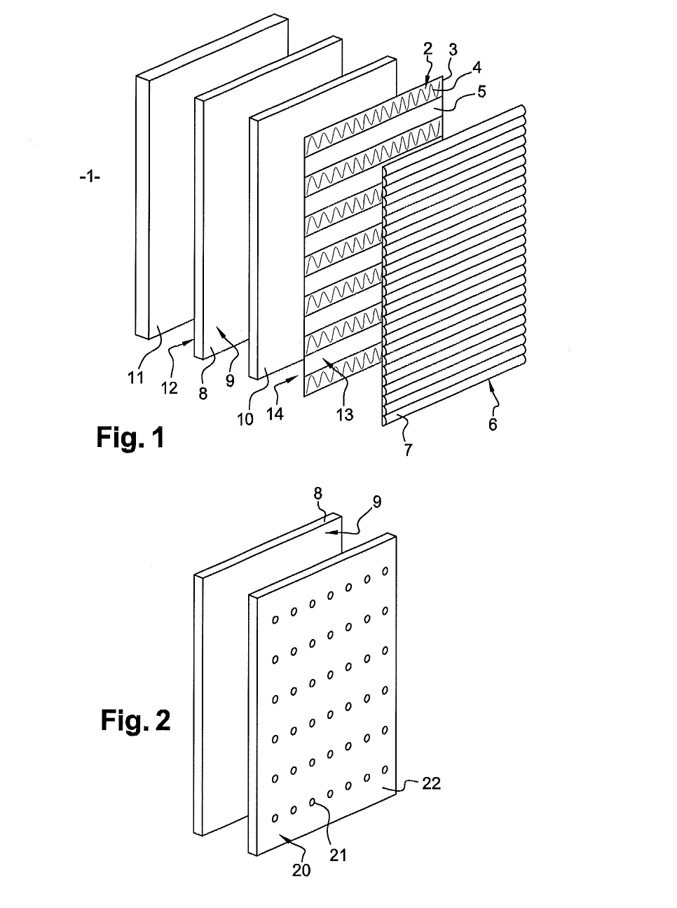

Such as shown in FIG. 1, such a printed panel 1 comprises a film 3 on which the image 2 is placed and formed by a plurality of parallel opaque bands 4 that are regularly spaced from each other. Such parallel opaque bands 4 are moreover separated by transparent bands 5 of the same width.

Facing a front side 13 of the film 3 is positioned an optical system 6 that makes it possible, on the one hand, to create the optical illusion that the image 2 is formed by a plurality of contiguous parallel opaque bands 4, and, on the other hand, for the solar radiation to pass through the transparent bands 5 in order to be collected by a photovoltaic panel 8.

Such an optical system 6 may thus comprise a plurality of rectilinear lenses 7 arranged parallel relative to the opaque 4 and transparent 5 bands of the film 3.

Moreover, a backlighting device 10 is arranged facing a back side 14 of the film 3 so as to allow the image 2 to be seen in the absence of sunlight.

Such a backlighting device 10 also allows, at least temporarily, at least some of the sunlight passing through the transparent bands 5 of the film 3 to be transmitted in order to be collected by the photovoltaic panel 8.

Moreover, such a photovoltaic panel 8 comprises a side 9 intended to collect sunlight and a back side 12 facing which a means 11 for storing the electrical power generated by the photovoltaic panel 8 may be placed.

Of course, the invention is not limited to this particular embodiment incorporating such a storing means 11. Specifically, in other variants (not shown), the means for storing the electrical power generated by the panel may also be positioned in a base of the panel or even be located remotely, separate from the printed panel.

The exploded perspective view of the printed panel shown in FIG. 1 allows the various constituent components thereof to be seen; however, such a printed panel 1 has, once assembled, a thin planar geometry that may especially be smaller than 10 cm and preferably smaller than 5 cm in thickness.

In addition, the backlighting device shown here schematically may be formed in various ways. A plurality of variants allowing such a backlighting device to be formed will now be described below with reference to FIGS. 2 to 5.

Thus, such as shown in FIG. 2, the backlighting device 20 may comprise a plurality of point sources 21 distributed in a plane parallel to that in which the film 3 is located. Such point sources 21 may especially consist of light-emitting diodes that are oriented so as to directly illuminate the back side 14 of the film 3. Such as shown, the point sources 21 may be positioned on a carrier 22 inserted between the photovoltaic panel 8 and the film 3. Such a carrier 22 may especially take the form of a transparent sheet or film made of polymethyl methacrylate (PMMA), polystyrene (PS), polycarbonate (PC) or even of glass.

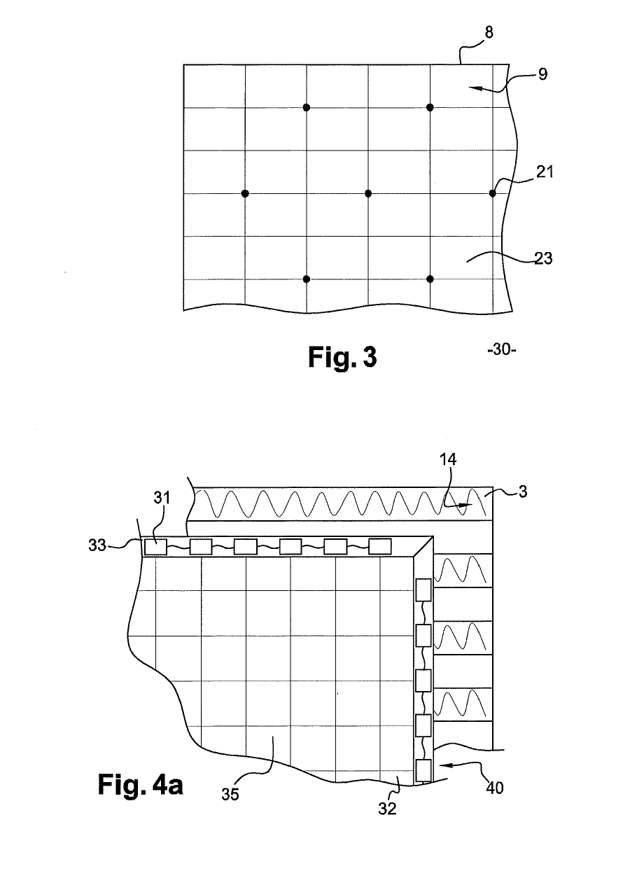

According to another variant, and such as shown in FIG. 3, the backlighting device 30 may comprise point sources 21 positioned directly on the side 9 intended to capture sunlight of the photovoltaic panel 8.

Such point sources 21 are then arranged level with inactive zones of the photovoltaic panel 8. Such inactive zones are generally located at the interstices separating four cells 23 of the photovoltaic panel 8.

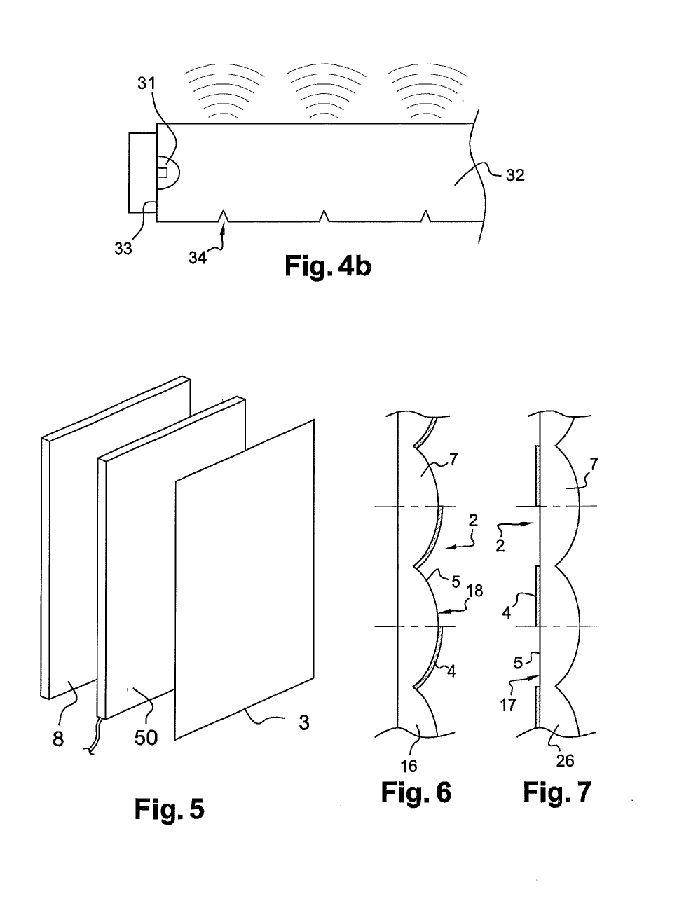

Such as shown in FIGS. 4a and 4b, the backlighting device 40 may comprise a transparent sheet 32 and point sources 31 arranged on the periphery of the transparent sheet 32.

Such point sources 31 are then oriented so as to illuminate the edge face 33 of the transparent sheet 32 and to orientate their luminous radiation toward the interior of the transparent sheet 32.

Moreover, grooves 34 allow the light thus produced to be reflected in the direction of the back side 14 of the film 3. Such grooves 34 thus form a network of parallel lines 35 arranged on a back side of the transparent sheet 32.

According to another embodiment (not shown), it may also be envisioned to position the network of parallel lines on a front side of the transparent sheet in order to transmit light in the direction of the back side of the film.

The spacing between two consecutive lines 35 may for its part vary as a function of the distance separating the lines 35 from a parallel edge face 33 of the transparent sheet 32. Thus, the density of the lines 35 may increase with distance from the edge face of the transparent sheet 32. Such an arrangement then makes it possible to gradually increase the amount of light reflected by the grooves 34 as the distance to the point sources 31 increases. This then allows the uniformity of the light emitted by the backlighting device 40 level with the back side 14 of the film 3 to be increased.

Such as shown in FIG. 5, another variant of the backlighting device 50 consists of a completely illuminating area inserted between the photovoltaic panel 8 and the film 3. Such a completely illuminating area may especially use an organic LED (OLED) technology and be formed by an illuminating film when the latter is supplied with electrical power.

Moreover, the various backlighting devices 10, 20, 40, 50 may also comprise a white background so as to improve the scattering of the light. Such a white background is then positioned on the back side of the backlighting device arranged facing the photovoltaic panel 8. Such a white background may also be formed by a liquid-crystal film and only allow light to be scattered when said film is supplied with electrical power.

During daylight periods, this liquid-crystal film is then deactivated and it thus becomes transparent and allows the light emitted by the sun to be transmitted in order to be collected by the photovoltaic panel.

Such as shown in FIGS. 6 and 7, the printed image 2 may also be printed directly on one side of the optical system 16, 26.

In the case shown in FIG. 6, the printed image 2 is printed on a front side 18 of the optical system 16. The opaque bands 4 are then arranged on lower cylindrical portions of the parallel lenses 7. The transparent bands 5 are for their part arranged level with upper cylindrical portions of the parallel lenses 7.

In contrast, in the case shown in FIG. 7, the printed image 2 is printed on a back side 17 of the optical system 16. The opaque bands 4 may then be arranged on flat surfaces positioned facing the lower cylindrical portions of the parallel lenses 7. The transparent bands 5 for their part are arranged on flat surfaces positioned facing the upper cylindrical portions of the parallel lenses 7.

It will be clear from the above that a printed panel according to the invention has many advantages, and in particular:
it allows an image to be backlit in the absence of luminous solar radiation;
it also makes it possible, by collecting and storing luminous radiation from the sun, to make the printed panel electrically autonomous; and
it also allows a motorized means, allowing a banner on which a plurality of images are printed to be scrolled, to be supplied with power.

1. A printed panel allowing an image to be displayed, comprising:
at least one printed image formed by a plurality of parallel opaque bands regularly spaced from each other and separated by transparent bands;
an optical system formed by a juxtaposition of rectilinear lenses, said rectilinear lenses of the optical system being arranged parallel to said plurality of opaque and transparent bands of the printed image; and
at least one photovoltaic panel, a side of the photovoltaic panel which is intended to collect sunlight being arranged facing a back side of said optical system;
said printed panel comprising at least one backlighting device arranged facing said back side of the optical system, said backlighting device being able to backlight the printed image, allowing the printed image to be seen in the absence of sunlight, and being able to allow, at least temporarily, at least some of the sunlight passing through said transparent bands of the printed image to be collected by the photovoltaic panel.

2. The panel as claimed in claim 1, wherein the printed image is disposed on a film interposed between said back side of the optical system and the side of the photovoltaic panel intended to collect sunlight.

3. The panel as claimed in claim 1, wherein the printed image is printed on the front side of the optical system .

4. The panel as claimed in claim 1, wherein the printed image is printed on the back side of the optical system.

5. The panel as claimed in claim 1, wherein said backlighting device comprises a plurality of point sources.

6. The panel as claimed in claim 5, wherein said point sources of the backlighting device are regularly distributed in a plane parallel to that in which said optical system is located while being oriented so as to directly illuminate the back side of the optical system.

7. The panel as claimed in claim 6, wherein the point sources of the backlighting device are arranged on a carrier disposed between the photovoltaic panel and the optical system.

8. The panel as claimed in claim 6, wherein the point sources of the backlighting device are arranged on the photovoltaic panel on said side intended to collect sunlight.

9. The panel as claimed in claim 5, wherein the backlighting device comprises a transparent sheet, said point sources being arranged on the periphery of the transparent sheet and being oriented so as to illuminate the edge face of the transparent sheet.

10. The panel as claimed in claim 9, wherein said transparent sheet comprises a plurality of grooves intended to reflect the light in the direction of the back side of said optical system.

11. The panel as claimed in claim 10, wherein the plurality of grooves forms a network of parallel lines, the spacing between two consecutive lines varying as a function of the distance separating said lines and a parallel edge face of the transparent sheet.

12. The panel as claimed in claim 7, wherein the transparent sheet transmits at least 95% of the incident sunlight in the direction of the photovoltaic panel.

13. The panel as claimed in claim 1, wherein said backlighting device is formed by a completely illuminating area inserted between the photovoltaic panel and the optical system.

14. The panel as claimed in claim 1, wherein the panel comprises a means for storing electrical power generated by said photovoltaic panel, said storing means having a planar geometry and extending facing a back side of the photovoltaic panel.
